(19) United States
(12) Patent Application Publication
(10) Pub. No.: US 2016/0316613 A1
(43) Pub. Date: Nov. 3, 2016

(54) SEED SPACING SYSTEM FOR A SEED PLANTER

(71) Applicant: STEERING SOLUTIONS IP HOLDING CORPORATION, Saginaw, MI (US)

(72) Inventors: Matt R. Burk, Bay City, MI (US); Nicholas R. Alpers, Saginaw, MI (US); David L. Westphal, Midland, MI (US)

(21) Appl. No.: 15/142,718

(22) Filed: Apr. 29, 2016

Related U.S. Application Data
(60) Provisional application No. 62/155,066, filed on Apr. 30, 2015.

(51) Int. Cl. A01C 7/10; A01C 7/20

(52) U.S. Cl. CPC A01C 7/102; A01C 7/203

(57) ABSTRACT

A seed spacing system for a seed planter is provided. The seed spacing system includes a plurality of row units of the seed planter, each of the row units having a seed planting device configured to dispense seeds at a specified interval. Also included is at least one position sensor for monitoring ground speed of the seed planting device, each seed planting device individually adjustable based on the speed detected by the position sensor.

### CROSS REFERENE TO RELATED APPLICATION

The patent application claims priority to U.S. Provisional Patent Application Ser. No. 62/155,066, filed Apr. 30, 2015, which is incorporated herein by reference in its entirety.

### BACKGROUND OF THE INVENTION

The embodiments described herein relate to a seed planter and, more particularly, to a seed spacing system for a seed planter.

Conventional planting implements currently used in farming operations, commonly referred to as “planters,” utilize a seed channel opener, typically in the form of a disc, that creates a channel or furrow in the soil for seed placement. The planters include at least one, but typically a plurality of row units that plant the seeds. Operators of planters desire a certain spacing between seed placement as the planter translates over the ground. In other words, it is desirable to plant a seed at certain spaced intervals in the direction of travel of the planter. During movement of the planter, the seeds are dispensed. However, during certain maneuvers, such as turning, uneven spacing is observed between different row units. This problem is exacerbated for particularly wide planters, which can be up to 90 feet wide or greater. Additionally, uneven terrain may lead to non-uniform seed spacing as well.

### SUMMARY OF THE INVENTION

According to one aspect of the disclosure, a seed spacing system for a seed planter is provided. The seed spacing system includes a plurality of row units of the seed planter, each of the row units having a seed planting device configured to dispense seeds at a specified interval. Also included is at least one position sensor for monitoring ground speed of the seed planting device, each seed planting device individually adjustable based on the speed detected by the position sensor.

According to another aspect of the disclosure, an automated seed spacing system for a seed planter includes a controller unit. Also included is a plurality of row units of the seed planter, each of the row units having a seed planting device configured to dispense seeds at a specified interval. Further included is a position sensor for monitoring ground speed of each row unit, the position sensor in operative communication with the controller unit. Yet further included is an electric motor disposed on each row unit and in operative communication with the controller unit to receive a signal therefrom, the electric motor operatively coupled to a respective seed planting device of each row unit to individually adjust the seed planting device based on the speed detected by the position sensor.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a partial view of seed planter towed by a tractor;

FIG. 2 is a perspective view seed spacing system of the planter;

FIG. 3 is a perspective view of a drive assembly of the seed spacing system; and

FIG. 4 is a perspective view of a gear arrangement of the drive assembly.

### DETAILED DESCRIPTION

Referring now to the Figures, where the invention will be described with reference to specific embodiments, without limiting same, a seed spacing system is provided to accurately and precisely control seed spacing in agricultural applications.

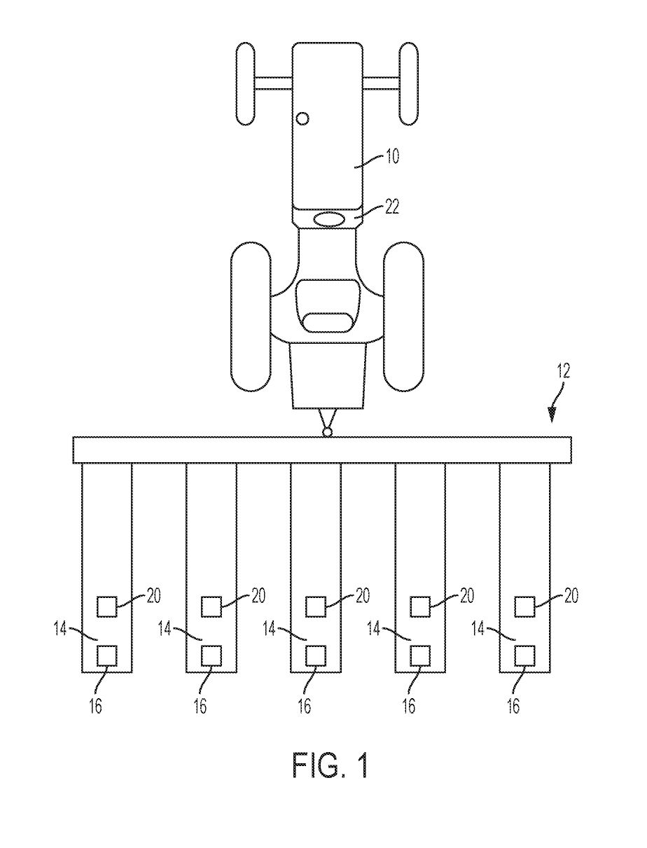

Referring to FIG. 1, schematically illustrated is a tractor 10 with a planter 12 hitched thereto. Although not illustrated in detail, the planter 12 comprises a fixed main frame having tires attached thereto for movement along the ground. The planter 12 includes a disc assembly that is used to cut a channel for a seed to be placed. The disc assembly is operatively coupled to a gauge wheel that is used to set ground penetration depth during a seed planting operation. The gauge wheel is operatively coupled to a gauge wheel pivot axle.

As shown, the planter 12 includes a plurality of row units 14 that are spaced from each other in a lateral direction. Each of the row units 14 translates over the ground and plants seeds at spaced intervals along the direction of travel of the respective row unit. The desired spaced intervals are predetermined by an operator. As one can appreciate, if the seed dispensing is based on a given time interval, as the planter 12 makes a turn, the row units dispense the seeds at varied intervals due to the distinct angular velocities at which each row unit experiences. This is attributed to the differing radii of curvature of the plurality of row units 14 during a turning maneuver. For example, during a wide turn, the row unit at the innermost location of the turn distributes a number of seeds over a smaller area relative to a row unit at an outermost location. This leads to more concentrated seed planting at the innermost row unit relative to the sparse seed planting at the outermost row unit. This problem is more prominent as the width of the planter increases. The number of row units and the total width of the planter in the lateral direction may vary based upon the particular application and it is to be appreciated that the width may exceed 90 feet in some cases.

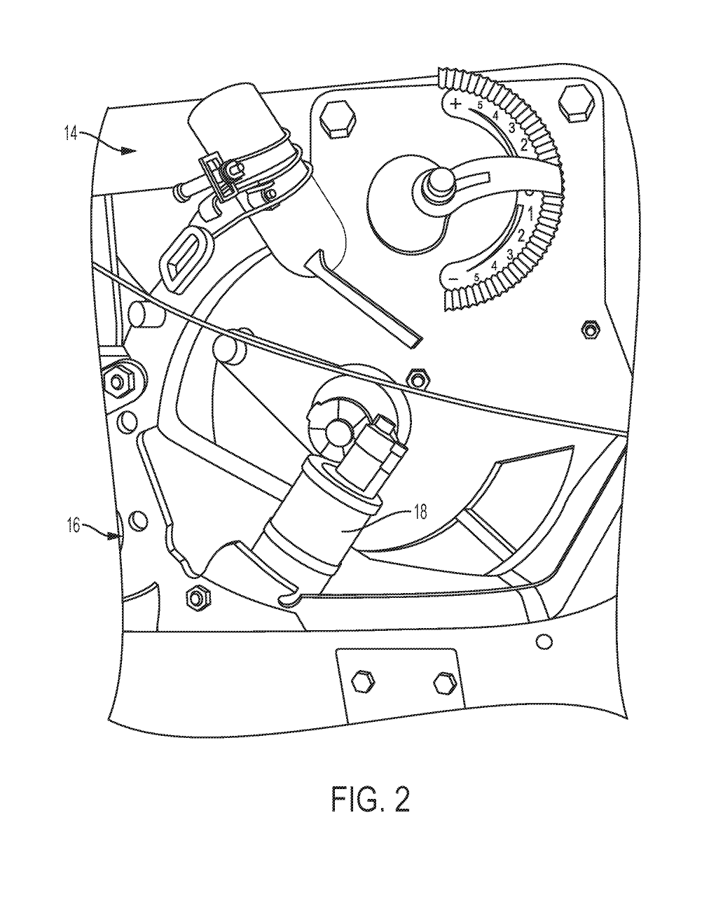

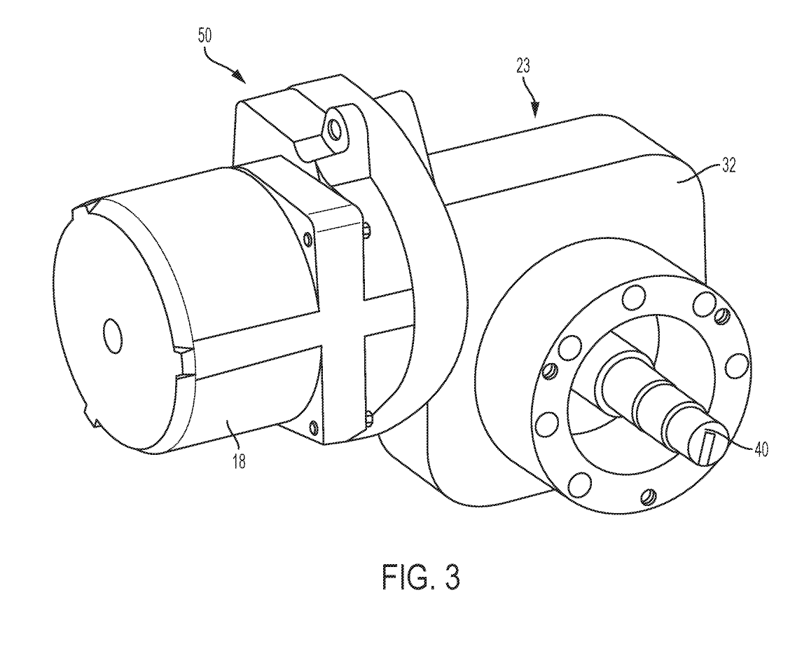

Referring now to FIG. 2, with continued reference to FIG. 1, to overcome the above-described issues, the embodiments described herein provide a seed spacing system 16 which electrically meters the seed spacing. The system 16 includes a position sensor 20 that is operatively coupled to the gauge wheel axle to take speed measurements during operation. A signal is sent from the position sensor 20 to an electric drive motor 18 and to a controller unit 22 in the tractor 10. The controller unit 22 includes a monitor for the operator to interact with. The operator can then monitor and control the seed spacing during operation. The electric drive motor 18 is operatively coupled to at least one component or assembly that adjusts the seed spacing by adjusting a main seed plate. In particular, the electric drive motor 18 is operatively coupled to a main seed plate drive shaft 40 (FIG. 3) that is coupled to the main seed plate for adjustment thereof, as described in detail below. This operation is carried out over each of the row units 14 to independently monitor and control the seed spacing for each row unit rather than relying on a single control scheme that is uniformly applied across all row units 14.

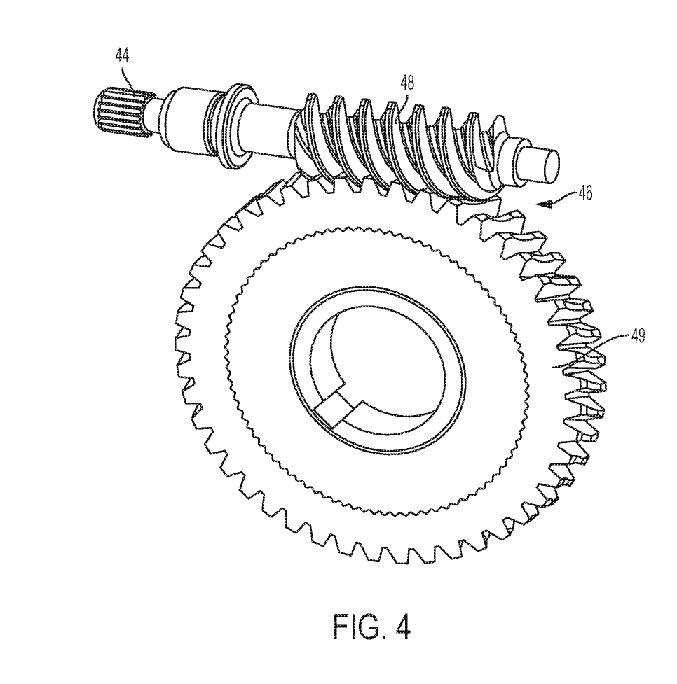

Referring now to FIGS. 3 and 4, a drive assembly 50 of the seed spacing system 16 is illustrated. FIG. 3 illustrates the drive assembly 50 with a housing assembly 23, while the housing assembly 23 is removed in FIG. 4 to better illustrate certain features of the system drive assembly 50. The electric drive motor 18 is illustrated and includes an output shaft 44. The particular type of electric motor employed may vary depending upon the particular application, but in some embodiments, the electric drive motor 18 is a 3-phase, 12 Volt DC motor. In such embodiments, the 12 Volt DC motor allows for direct wiring power from a tractor battery.

Irrespective of the type of motor, the output shaft 44 is operatively coupled to a worm gear arrangement 46 that is non-back drivable to drive the worm gear arrangement 46. More particularly, the output shaft 44 is operatively coupled to a worm 48 of the arrangement 46, which rotates a worm wheel 49 that the worm 48 is engaged with. The gear ratio of the worm gear arrangement 26 may vary depending upon the particular application, but in some embodiments a 15:1 worm gear box is employed. As shown in FIG. 3, the housing assembly 23 includes a gearbox housing 32 that environmentally seals the worm gear arrangement 46 to maintain operational integrity of the worm gear arrangement 46.

The worm wheel 49 is operatively coupled to, or integrally formed with, the main plate seed drive shaft 40 to adjust seed spacing based on speed detection with the above-described position sensor 20 placed on each row unit 14.

In operation, an operator provides an input with the controller unit 22 (FIG. 1) to send a signal to the electric motor 18, which drives the worm gear arrangement 46 to rotate the main seed plate drive shaft 40. Rotation of the main seed plate drive shaft 40 results in adjustment of the main seed plate to controls the seed planting spacing.

Advantageously, the seed spacing system 16 allows for varying ground speed across multiple row units as wider planters translate curved or angled profiles within the field. Additionally, dual row unit planters will benefit from the seed spacing system 16 by being able to program alternating seed spacing within the same row units. This allows for the operator to maximize efficiency of soil usage.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A seed spacing system for a seed planter comprising:
a plurality of row units of the seed planter, each of the row units having a seed planting device configured to dispense seeds at a specified interval; and
at least one position sensor for monitoring ground speed of the seed planting device, each seed planting device individually adjustable based on the speed detected by the position sensor.

2. The seed spacing system of claim 1, wherein each of the row units includes a respective position sensor.

3. The seed spacing system of claim 1, wherein the seed planting device comprises a main seed plate that is adjustable to modify the specified interval for seed dispensing.

4. The seed spacing system of claim 3, further comprising a drive assembly that adjusts the main seed plate, the drive assembly comprising:
a main seed plate drive shaft operatively coupled to the main seed plate; and
an electric motor operatively coupled to the main seed plate drive shaft to rotatably drive the main seed plate drive shaft.

5. The seed spacing system of claim 4, wherein the electric motor is a 3-phase, 12 Volt DC motor.

6. The seed spacing system of claim 4, further comprising a gear arrangement operatively coupling the electric motor to the main seed plate drive shaft.

7. The seed spacing system of claim 6, wherein the gear arrangement comprises a worm operatively coupled to an output shaft of the electric motor and a worm wheel, the worm wheel operatively coupled to the main seed plate drive shaft.

8. The seed spacing system of claim 6, further comprising a housing assembly environmentally sealing a portion of the drive assembly.

9. The seed spacing system of claim 8, wherein the housing assembly includes a gearbox housing that environmentally seals the gear arrangement.

10. An automated seed spacing system for a seed planter comprising:
a controller unit;
a plurality of row units of the seed planter, each of the row units having a seed planting device configured to dispense seeds at a specified interval;
a position sensor for monitoring ground speed of each row unit, the position sensor in operative communication with the controller unit; and
an electric motor disposed on each row unit and in operative communication with the controller unit to receive a signal therefrom, the electric motor operatively coupled to a respective seed planting device of each row unit to individually adjust the seed planting device based on the speed detected by the position sensor.

11. The automated seed spacing system of claim 10, wherein the controller unit is fixed at an onboard location of a tractor configured to tow the seed planter.

12. The automated seed spacing system of claim 10, wherein the controller unit is a portable device.

13. The automated seed spacing system of claim 10, further comprising a main seed plate of each row unit that is adjustable to modify the specified interval for seed dispensing.

14. The automated seed spacing system of claim 13, further comprising a drive assembly that adjusts the main seed plate, the drive assembly comprising a main seed plate drive shaft operatively coupled to the main seed plate, the electric motor operatively coupled to the main seed plate drive shaft to rotatably drive the main seed plate drive shaft.

15. The automated seed spacing system of claim 10, wherein the electric motor is a 3-phase, 12 Volt DC motor.

16. The automated seed spacing system of claim 14, further comprising a gear arrangement operatively coupling the electric motor to the main seed plate drive shaft.

17. The automated seed spacing system of claim 16, wherein the gear arrangement comprises a worm operatively coupled to an output shaft of the electric motor and a worm wheel, the worm wheel operatively coupled to the main seed plate drive shaft.

18. The automated seed spacing system of claim 16, further comprising a housing assembly environmentally sealing a portion of the drive assembly.

19. The automated seed spacing system of claim 18, wherein the housing assembly includes a gearbox housing that environmentally seals the gear arrangement.
